(19) United States
(12) Patent Application Publication
(10) Pub. No.: US 2013/0132834 A1
(43) Pub. Date: May 23, 2013

(54) ELECTRONIC DEVICE CAPABLE OF GENERATING LEARNING INTERFACE BASED ON USER EXPERIENCE

(71) Applicants: YING-CHUAN YU, Tu-Cheng (TW); YING-XIONG HUANG, Tu-Cheng (TW)

(72) Inventors: YING-CHUAN YU, Tu-Cheng (TW); YING-XIONG HUANG, Tu-Cheng (TW)

(73) Assignee: HON HAI PRECISION INDUSTRY CO., LTD., Tu-Cheng (TW)

(21) Appl. No.: 13/339,381

(22) Filed: Dec. 29, 2011

(30) Foreign Application Priority Data
Nov. 18, 2011 (TW) 100142453

(51) Int. Cl. G06F 3/048

(52) U.S. Cl. 715/708

(57) ABSTRACT

An electronic device includes an input unit, a storage unit to store a database that defines several menu item groups. Each menu item group includes several menu items that are associated with each other. A processor starts a learning mode in response to a user input from the input unit, and in the learning mode, the processor receives an user input relating to one or more menu items, determines one or more menu item groups based on the user input, and generates a learning menu based on the one or more menu item groups.

### BACKGROUND

1. Technical Field

The present disclosure relates to electronic devices, and particularly, to an electronic device capable of generating a learning interface based upon user experience.

2. Description of Related Art

As technologies advance, smart devices such as smartphones are developed with complicated functions. Many people may find it difficult to adapt to the complicated functions. Thus, it is desirable and useful to provide an electronic device that can provide a learning interface that can facilitate a quick adaption to the device for the people.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic block diagram of an electronic device in accordance with an embodiment.

FIG. 2 shows associated menu items defined by a database stored on a storage unit of the electronic device of FIG. 1.

FIGS. 3 and 4 are prompt interfaces provided in a learning mode.

### DETAILED DESCRIPTION

Embodiments of the present disclosure will now be described in detail with reference to the accompanying drawings.

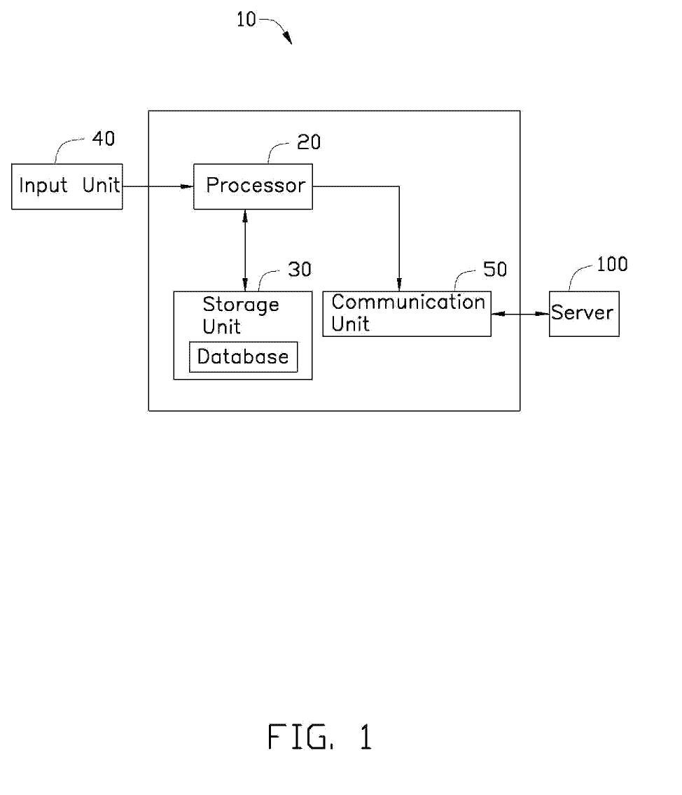

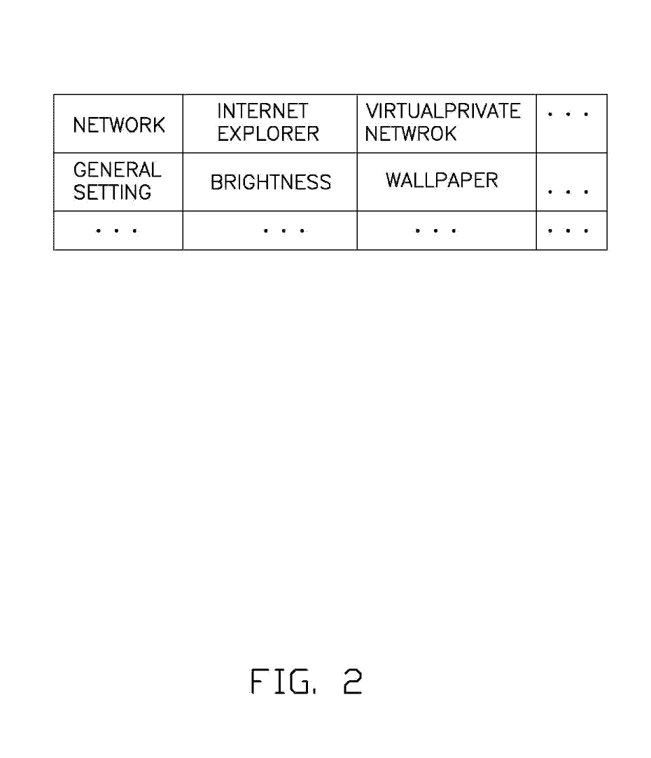

Referring to FIGS. 1 and 2, an electronic device 10 includes a processor 20, a storage unit 30, an input unit 40, and a communication unit 50. In the embodiment, the electronic device 10 can be a cell phone or a tablet computer.

The storage unit 30 stores a database. Initially the database stores a number of pre-defined menu item groups, each of which includes several menu items that are associated with each other. Each menu item corresponds to a software that can be run on the electronic device 10. The menu item groups have been created based on studies of user experience with smartphones and tablet computers. For example, it was found that the menu item “INTERNET EXPLORER” is the most selected menu item after the menu item “NETWORK” is selected. The menu items “INTERNET EXPLORER” and “NETWORK” are then associated. In this manner, all the menu items of the electronic device 10 can be classified into corresponding menu item groups.

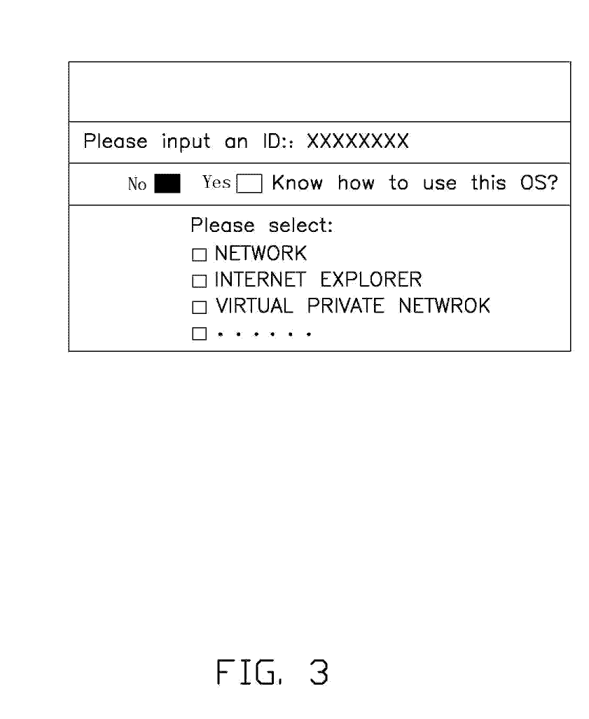

The input unit 40 can receive a user input to start a learning mode. In the embodiment, the input unit 40 is a physical keyboard. In an alternative embodiment, the input 40 can be a virtual keyboard. As shown in FIG. 3, in the learning mode, a prompt interface is first provided to prompt a user to input a user ID and select between an option item “YES” indicating that a user knows how to use the operating system of the electronic device 10, and an option item “NO” indicating that a user does not know how to use the operating system of the electronic device 10. If the option item “NO” is selected, the user is further prompted to select one or more menu items of interest. For example, the user may like to know how to access internet through the electronic device 10, and can select the menu item “NETWORK”, or if the user wants to learn how to browse websites on the internet they can select the menu item “INTERNET EXPLORER.”

The processor 20 receives the input menu items of interest and determines the menu item group(s) to which the input menu items belong according to the database stored in the storage unit 30. The processor 20 then generates a learning interface to show how to use the software corresponding to the input menu items and their associated menu items. For example, if the user selects the menu item “INTERNET EXPLORER”, the processor 20 can generate a learning interface to show how to use the software corresponding to the menu item “INTERNET EXPLORER,” and to show how to set the associated menu item “NETWORK.” As a result, a user can quickly learn how to get internet access using the “NETWORK” menu item, and how to surf the internet using the “INTERNET EXPLORER” menu item.

In the embodiment, the processor 20 records and analyzes user operations in the learning mode and updates the database accordingly. The communication unit 50 can communicate with a host server 100, enabling uploading the updated database to the host server 100. In alternative embodiment, the electronic device 10 can obtain updates for the database from the host server through the communication unit 50. In the embodiment, the communication unit 50 may be a WiFi module.

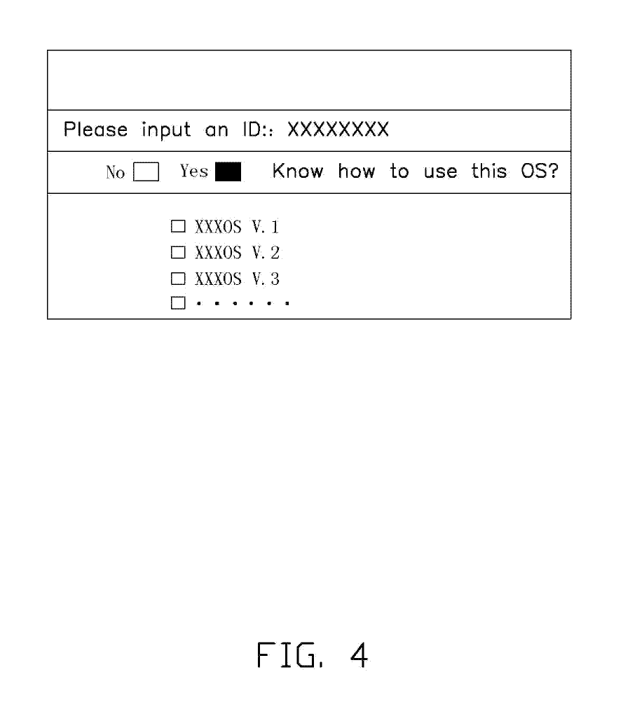

As shown in FIG. 4, if the option item “YES” is selected, the user is further prompted to select a used edition of the operating system from a listed editions. The processor 20 then make a comparison between the edition of the used operating system and the current edition of the operation system of the electronic device 10. If the former and the latter are different, the processor 20 will control the prompt interface to list only the software that have been updated.

While various embodiments have been described and illustrated, the disclosure is not to be construed as being limited thereto. Various modifications can be made to the embodiments by those skilled in the art without departing from the true spirit and scope of the invention as defined by the appended claims.

What is claimed is:

1. An electronic device comprising:
an input unit;
a storage unit configured to store a database, the database defining plurality of menu item groups, each menu item group comprising a plurality of menu items that are associated with each other; and
a processor, wherein the processor starts a learning mode in response to a user input from the input unit, in the learning mode, the processor receives a user selection of selecting one or more listed menu items, determines one or more menu item groups based on the user selection, and generates a learning menu based on the one or more menu item groups.

2. The electronic device according to claim 1, wherein the processor records and analyzes user operation in the learning mode, and updates the database based on an analysis result.

3. The electronic device according to claim 1, further comprising a wireless communication module to wirelessly communicate with a host server to obtain updates for the database.

4. The electronic device according to claim 1, further comprising a wireless communication module to wirelessly communicate with a host server, wherein the processor records and analyzes user operation in the learning mode, and updates the database based on an analysis result, and the updated database is transferred to the host server through the wireless communication module.

5. The electronic device according to claim 1, wherein the input unit is a keyboard.

6. The electronic device according to claim 4, wherein the wireless communication module is a WiFi module.
